(19) United States
(12) Patent Application Publication
(10) Pub. No.: US 2026/0046154 A1
(43) Pub. Date: Feb. 12, 2026

(54) BUS ARRANGEMENT AND METHOD FOR OPERATING A BUS ARRANGEMENT

(71) Applicant: EATON INTELLIGENT POWER LIMITED, Dublin 4 (IE)

(72) Inventor: Georg REIDT, Swisttal, NRW (DE)

(21) Appl. No.: 18/998,694

(22) PCT Filed: Aug. 15, 2023
(86) PCT No.: PCT/EP2023/025378

§ 371 Date: Jan. 27, 2025

(30) Foreign Application Priority Data
Aug. 17, 2022 (GB) 2212024.0

(51) Int. Cl. H04L 12/12; H04L 12/403; H04L 61/5038

(52) U.S. Cl. CPC H04L 12/12; H04L 12/403; H04L 61/5038

(57) ABSTRACT

Some embodiments relate to a coordinator; a plurality of subscribers, each comprising a button, a memory and a display; and a bus which couples the coordinator to the plurality of subscribers. The coordinator and the plurality of subscribers are configured to be set in an addresses allocation mode. In the addresses allocation mode, the coordinator is configured to indicate a first subscriber number and to broadcast a first broadcast message to the plurality of subscribers. In the addresses allocation mode after activation of a button of a first subscriber of the plurality of subscribers, the first subscriber is configured to be activated and to send an acknowledge message to the coordinator.

### CROSS-REFERENCE TO RELATED APPLICATIONS

This application is a national phase filing under 35 C.F. R. § 371 of and claims priority to PCT Patent Application No. PCT/EP2023/025378, filed on, Aug. 15, 2023, which claims the priority benefit under 35 U.S. C. § 119 of Great Britain Patent Application No. 2212024.0, filed on Aug. 17, 2022, the contents of which are hereby incorporated in their entireties by reference.

### DESCRIPTION

The present disclosure is related to a bus arrangement and a method for operating a bus arrangement.

A bus arrangement includes a coordinator, a plurality of subscribers and a bus. A bus may use a daisy chain control wire to provide addresses to the subscribers automatically. This is in general a very simple and effective way to allocate addresses to the subscribers. However, some types of a bus do not use auto addressing with a daisy chain control wire. Alternatively, an address can be assigned to a subscriber by means of coding switches. Thus, another addresses allocation method for a bus without a daisy chain control wire or for subscribes without coding switches has to be used.

It is an object to provide a bus arrangement and a method for operating a bus arrangement with a high flexibility.

This object is achieved by the subject-matter of the independent claims. Further developments and embodiments are described in the dependent claims.

There is provided a bus arrangement, comprising a coordinator, a plurality of subscribers and a bus. Each subscriber of the plurality of subscribers comprises a button, a memory and a display. The bus couples the coordinator to the plurality of subscribers. The coordinator and the plurality of subscribers are configured to be set in an addresses allocation mode. In the addresses allocation mode, the coordinator is configured to indicate a first subscriber number and to broadcast a first broadcast message to the plurality of subscribers. In the addresses allocation mode after activation of a button of a first subscriber of the plurality of subscribers, the first subscriber is configured to be activated and to send an acknowledge message to the coordinator.

Advantageously, the button of the first subscriber is pushed or switched by a user. Thus, the user selects which subscriber of the plurality of subscribers is the first subscriber and receives the first subscriber number. This allows a high flexibility for designing the bus arrangement.

In an embodiment of the bus arrangement, the coordinator comprises a coordinator display and is configured to indicate the first subscriber number on the coordinator display

Additionally or alternatively, the coordinator is configured to indicate the first subscriber number on an external display.

In an example, the coordinator comprises an antenna and is configured to send the first subscriber number to a mobile phone or tablet of a user. The coordinator communicates with the mobile phone or tablet, e.g., using Bluetooth (RTM) or near field communication. Thus, the coordinator transmits the first subscriber number to the mobile phone or tablet of the user such that the mobile phone or tablet of the user shows the first subscriber number on a display of the mobile phone or tablet.

In an embodiment of the bus arrangement, the coordinator display is realized, e.g., as a flat-panel display. The display is implemented, e.g., as a seven segment display or a dot-matrix display. The display is realized, e.g., as a liquid-crystal display (abbreviated LCD), light-emitting diode display (abbreviated LED display) or an organic light-emitting diode display (abbreviated OLED display).

### After Activation the First Subscriber Can Be Named Activated First Subscriber.

In an embodiment of the bus arrangement, in the addresses allocation mode, the first subscriber after activation is configured to send a unique device identification number together with the acknowledge message to the coordinator. The coordinator is configured to store the unique device identification number of the first subscriber, e.g., together with the first subscriber number in a coordinator memory of the coordinator. In an example, a subscriber can be named node. A subscriber number can be named node number.

In an embodiment of the bus arrangement, in the addresses allocation mode, the coordinator is configured to send a first subscriber number message comprising the first subscriber number to the first subscriber. In the addresses allocation mode, only the activated first subscriber of the plurality of subscribers is configured to store the first subscriber number in the memory of the first subscriber. The first subscriber number is, e.g., named first subscriber address.

In an embodiment of the bus arrangement, the first subscriber is configured to send a confirmation message to the coordinator after storing the first subscriber number in the memory.

In an embodiment of the bus arrangement, at the start of the addresses allocation mode the coordinator is configured to send a broadcast message to the plurality of subscribers such that each subscriber is set in a listen-only mode and the display of each subscriber indicates a first status. In an example, the subscribers are continuously able to listen and to send a message, e.g., to the coordinator. However, in the listen-only mode, the subscribers are not able to send a message to the coordinator and are able to listen. If or when the coordinator sends this broadcast message for node number assignment and all subscribers receive this broadcast message, then each subscriber switches to a special mode to receive a new subscriber number. The broadcast message can also be named telegram.

In an embodiment of the bus arrangement, after activation of the first subscriber or after storing the first subscriber number in the memory of the first subscriber, the first subscriber is configured to control the display such that the display indicates a second status.

In an embodiment of the bus arrangement, the display of one subscriber or each of the plurality of subscribers comprises a light-emitting diode, abbreviated LED.

In a further development the bus arrangement, the display of a subscriber is configured to indicate the first status by a flashing LED and to indicate the second status by a continuous emitting LED.

In an embodiment of the bus arrangement, the coordinator is configured to repeat the process until each of the plurality of subscribers has been activated and has received a subscriber number. Thus, for example, the plurality of subscribers additionally includes a second subscriber, a third subscriber etc. In an example, the coordinator is configured to provide the subscriber numbers as numbers without a number gap or as numbers with a number gap.

In an embodiment of the bus arrangement, the bus is realized as one of a group consisting of a two-wire bus, three-wire bus or four-wire bus.

In an embodiment of the bus arrangement, the bus is realized as a two-wire bus configured for energy transmission and data communication.

In an embodiment of the bus arrangement, the bus is realized as single pair Ethernet bus-abbreviated SPE bus.

In an embodiment of the bus arrangement, the bus is realized as a four-wire bus and is configured for separate energy transmission and data communication. In an example, two wires are configured for data communication. Two further wires are configured for providing a supply voltage and a reference potential.

In an embodiment of the bus arrangement, the bus is realized as one of a group consisting of RS-485 bus (also known as TIA-485(-A) or EIA-485 bus), a controller area network bus—abbreviated CAN bus, a Modbus or a Modbus remote terminal unit bus—abbreviated Modbus RTU bus.

In an embodiment of the bus arrangement, the bus is arranged as one of a group consisting of a linear bus, a star bus, a ring bus or a mixture of these bus forms.

In an embodiment of the bus arrangement, the coordinator is implemented as a gateway or master gateway. In an example, the coordinator has a first bus interface connected to the bus and a second bus interface configured for connection to a further bus.

In an embodiment of the bus arrangement, the coordinator is implemented as a programmable logic controller, abbreviated PLC. The coordinator includes, e.g., a user interface or user-machine interface. The coordinator comprises a first bus interface connected to the bus. In an example, the PLC is the main PLC or the central PLC of the bus arrangement. Thus, in an example, the coordinator is configured as a controller that centrally processes all data of the bus arrangement; the bus arrangement is a closed system. The coordinator is, e.g., free of a further bus interface.

### Alternatively, the Plc Is Configured As a Gateway.

In an embodiment of the bus arrangement, the coordinator is implemented as a master and the plurality of subscribers are implemented as slaves.

In an embodiment of the bus arrangement, a subscriber of the plurality of subscribers is one of a group consisting of a circuit breaker, power switch, protection switch, contactor, sensor and measuring device. A subscriber can be realized as an in-cabinet device or a field device. A subscriber can be implemented as a switch gear.

In an embodiment of the bus arrangement, a subscriber of the plurality of subscribers comprises an illuminated switch which comprises the button and the display.

There is provided a method for operating a bus arrangement. The bus arrangement comprises a coordinator, a plurality of subscribers, each comprising a button, a memory and a display, and a bus which couples the coordinator to the plurality of subscribers. The method comprises:
Setting the coordinator and the plurality of subscribers in an addresses allocation mode,
in the addresses allocation mode, indicating a first subscriber number by the coordinator and broadcasting a first broadcast message to the plurality of subscribers by the coordinator, and
in the addresses allocation mode after activation of a button of a first subscriber of the plurality of subscribers, activating the first subscriber and sending an acknowledge message by the first subscriber to the coordinator.

Advantageously, the subscriber that is designated to receive the first subscriber number is selected by a user which presses the button of this subscriber.

The method for operating a bus arrangement is implemented, e.g., by the bus arrangement according to one of the embodiments defined above. The features described in connection with the bus arrangement can therefore also be used for the method and vice versa.

In an example, the method is an addressing method for switch gear devices.

In an example, the method for operating is based on a process controlled by software in the coordinator and the subscribers, optical recognition and user interaction. The addressing can be used in different types of bus topologies (not only in a linear bus structure).

In an example, the method implements an addressing procedure for networked switching and control devices. The method is applied, e.g., within an industrial machine application but also in other applications with networked devices. With the help of the described procedure, addresses of subscribers can be assigned easily and flexibly, regardless of their electrical bus wiring and bus arrangement. The process is realized with the help of visualized status information and by pressing configuration buttons located on the subscribers as well as on the coordinator.

In an example, networked switching and control devices in the industrial environment are provided with unique addresses so that a coordinator addresses the subscribers unambiguously via message telegrams. The coordinator acts as bus master. A subscriber can be named participant or bus participant.

In an example, advantageously, the method allows to assign addresses to subscribers without coding switches. Furthermore, addressing is possible in the physical order of the subscribers according to the existing wiring or in an alternative order. This is an advantage in the case of extended networks with, e.g., additional bus lines. In addition, the address assignment is not rigid and can be varied by the user.

In an example, the configuration procedure is an interaction of sent and received bus telegrams as well as the operation of buttons on the corresponding subscribers. A display, status LEDs and a push-button are located on the coordinator. The display is, e.g., a seven-segment display or another display. On the subscriber side, a status LED and a push-button are located.

The following description of figures of embodiments may further illustrate and explain aspects of the multiport protection apparatus. Parts, structures and devices with the same structure and the same effect, respectively, appear with equivalent reference symbols. In so far as parts, structures or devices correspond to one another in terms of their function in different figures, the description thereof is not repeated for each of the following figures.

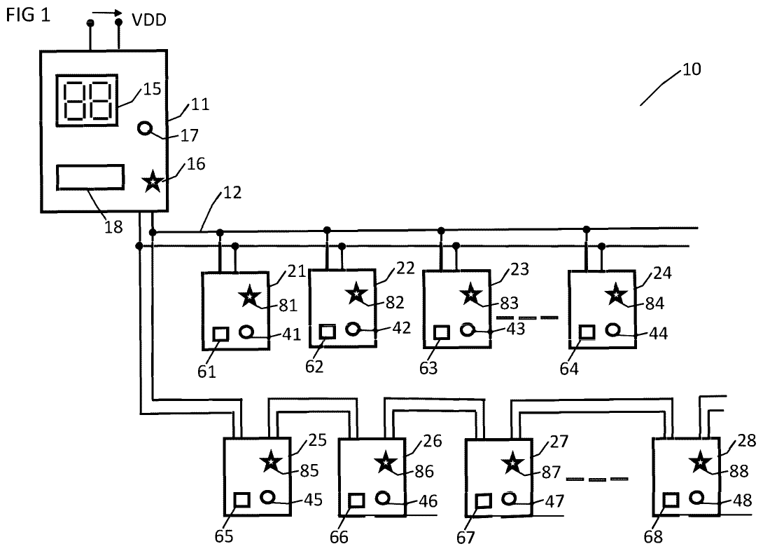

FIGS. 1 to 3 show embodiments of a bus arrangement,

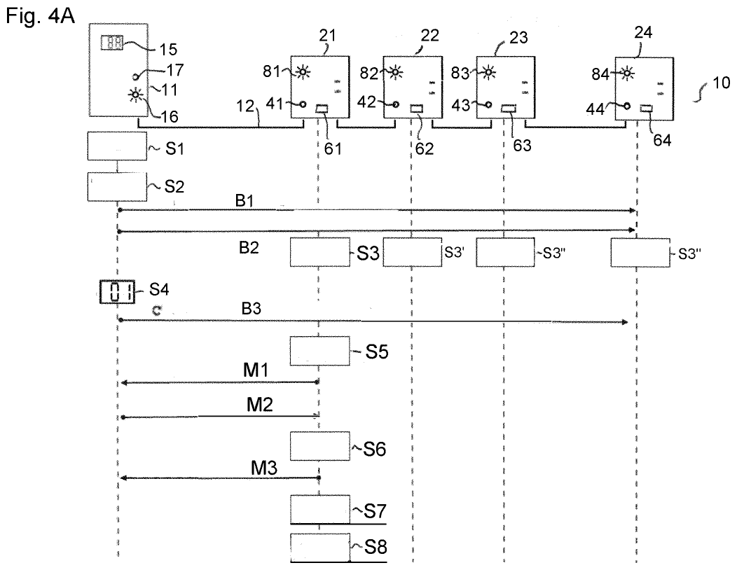

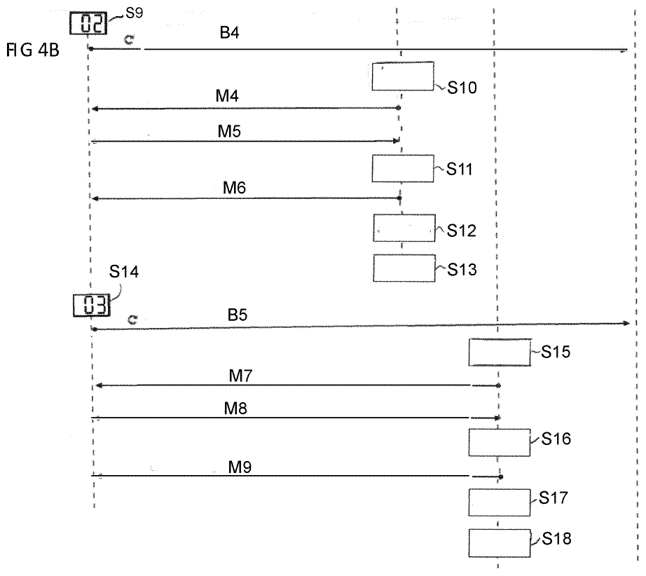

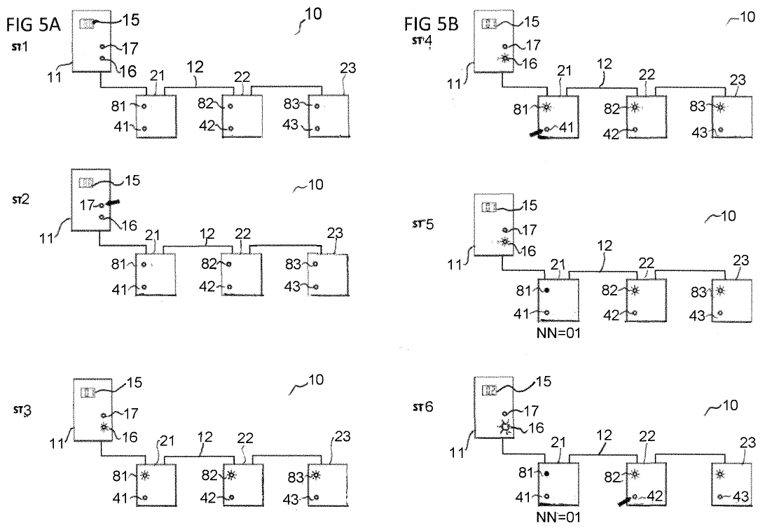

FIGS. 4A and 4B show an embodiment of a method,

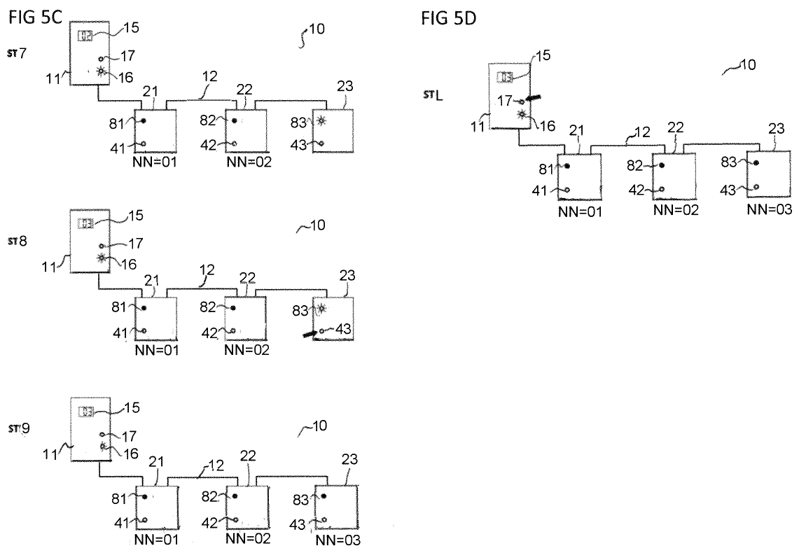

FIGS. 5A to 5D show a further embodiment of a method,

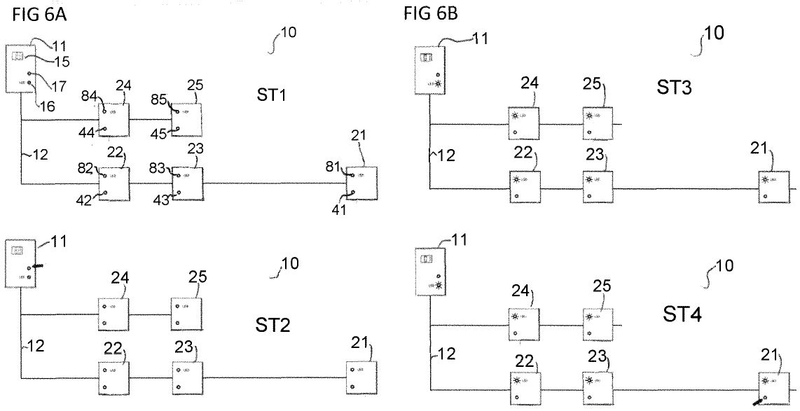

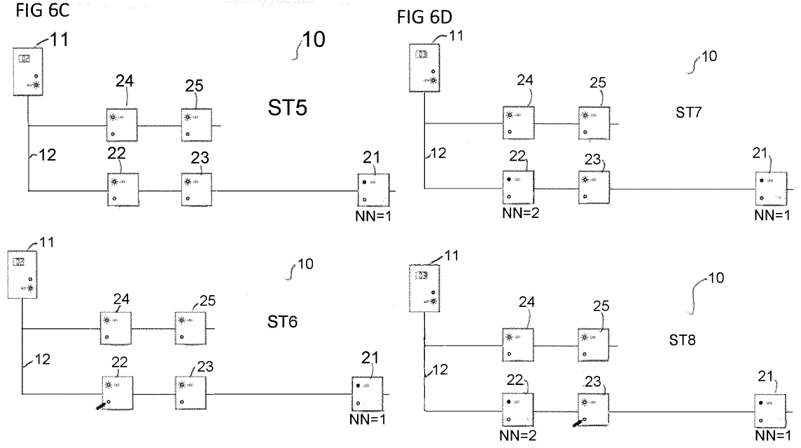

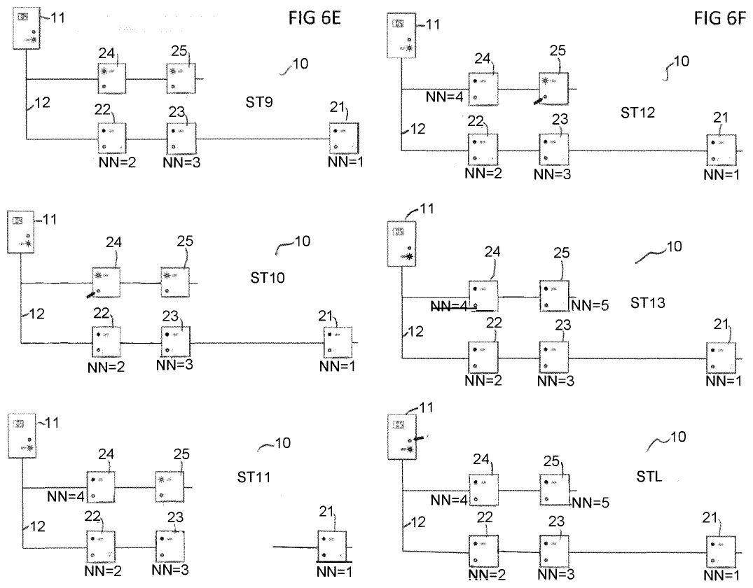

FIGS. 6A to 6F show an additional embodiment of a method, and

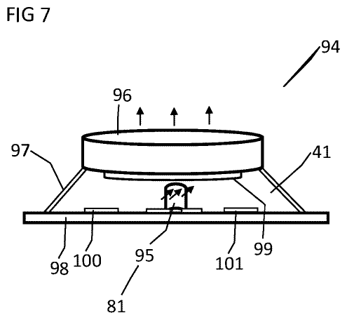

FIG. 7 shows details of an embodiment of a bus arrangement.

FIG. 1 shows an embodiment of a bus arrangement 10 that comprises a coordinator 11, a plurality of subscribers 21-28 and a bus 12. Each subscriber of the plurality of subscribers 21-28 comprises a button 41-48, a memory 61-68 and a display 81-88.

Thus, the plurality of subscribers 21-28 include a first subscriber 21 with a button 41, a memory 61 and a display 81, a second subscriber 22 with a button 42, a memory 62 and a display 82 etc. The button 41 of the first subscriber 21 is implemented, e.g., as push-button or switch. The switch is implemented, e.g., as a capacitive switch, mechanical switch, inductive switch, optical switch or membrane switch. The display 81-88 of each of the plurality of subscribers 21-28 comprises, e.g., a light-emitting diode, abbreviated LED. A subscriber of the plurality of subscribers 21-28 is, e.g., a circuit breaker or a power switch. The memory 61-68 is, e.g., a non-volatile memory. The memory 61-68 is, e.g., an electrically erasable programmable read-only memory (abbreviated EEPROM) or a flash memory. The buttons 41-48 are implemented, e.g., as push-buttons or switches.

The coordinator 11 comprises a coordinator display 15, a further coordinator display 16 and a coordinator button 17. The coordinator display 15 is able, e.g., to indicate numbers. For example, the coordinator display 15 is able, e.g., to indicate numbers with one digit, two digits or three digits. The coordinator display 15 is able, e.g., to indicate numbers with at least one digit or at least two digits. The further coordinator display 16 is able, e.g., to indicate a status. The further coordinator display 16 comprises, e.g., a LED. The coordinator 11 receives a supply voltage VDD. The supply voltage VDD is, e.g., 24 V. The coordinator 11 is implemented, e.g., as a gateway. The coordinator 11 is implemented as a master and the plurality of subscribers 21-28 are implemented as slaves. The coordinator 11 comprises a coordinator memory 18. The coordinator memory 18 is, e.g., an EEPROM or a flash memory. The coordinator 11 includes, e.g., a microprocessor, a microcontroller, logic gates or a state machine.

The bus 12 couples the coordinator 11 to the plurality of subscribers 21-28. The bus 12 is realized as two-wire bus. The bus 12 has a star form. The bus 12 realizes an energy transmission with additional bus communication (e.g., SPE bus).

The bus arrangement 10 shown in FIG. 1 is only an example. The bus arrangement 10 may include less subscribers or more subscribers.

In an alternative embodiment, the display 81-88 of a subscriber of the plurality of subscribers 21-28 is realized as a two-dimensional display, such as, e.g., a liquid crystal display (abbreviated LCD) or a light-emitting diode display (abbreviated LED display). In an example, the displays 81-88 of the plurality of subscribers 21-28 are different.

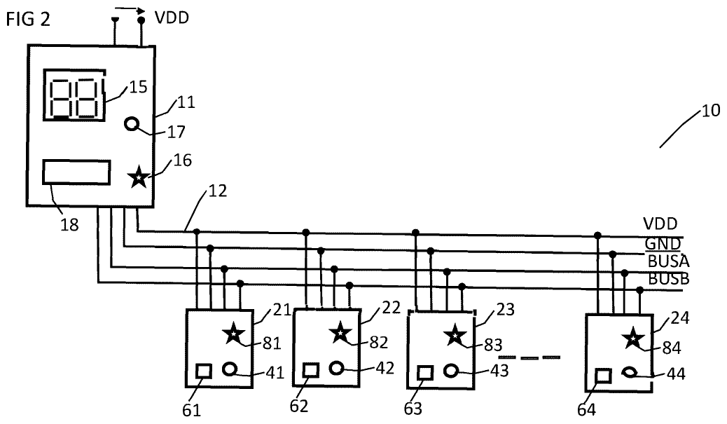

FIG. 2 shows an embodiment of a bus arrangement 10 which is a further development of the bus arrangement 10 shown in FIG. 1. The bus 12 is a two-wire bus (e.g., CAN bus or RS485 bus) with an additional power supply line and an additional ground line. Thus, the bus 12 includes four wires and could also be named four-wire bus. In the example shown in FIG. 2, the bus 12 has a linear structure.

The addressing process is semi-automated and works with push buttons 41-44, displays 81-84 realized as LED indicators on each subscriber 21-24 and the coordinator display 15. The coordinator display 15 is, e.g., a two-digit-display on a front side of the coordinator 11. The addressing process is started by pushing the coordinator button 17 by a user. Immediately an interaction process between the bus arrangement 10 and the user starts which guides through the addressing process with the help of the user.

Each Subscriber 21-24 Has a Subscriber Identifier Number UITN (stored in the Memory 61-64, e.g., during fabrication of the subscriber) and, after performing the method as described below, also a subscriber number NN.

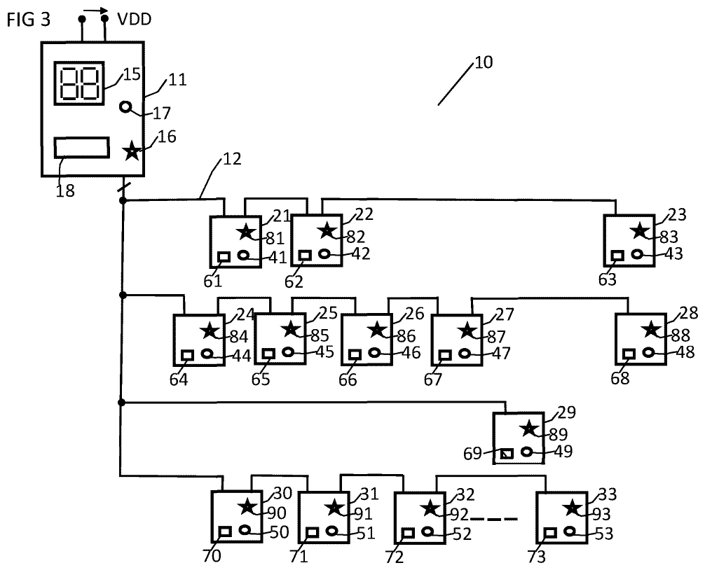

FIG. 3 shows an embodiment of a bus arrangement 10 which is a further development of the bus arrangement 10 shown in FIGS. 1 and 2. The bus 12 is realized, e.g., as two-wire bus or four-wire bus. The bus arrangement 10 is realized as a network which can be complex as shown in FIG. 3. The line lengths indicate that the subscribers 21 to 33 could also be distributed further apart or sit apart from each other. The subscribers 21 to 33 are located in a cabinet and/or the field. The bus 12 has a star form.

FIGS. 4A and 4B show an embodiment of a method which can be used, e.g., in the embodiments of the bus arrangement 10 shown in FIGS. 1 to 3. As shown in FIG. 4A, the method comprises the following steps:

Step S1: A user presses the coordinator button 17 longer than a predetermined duration. The predetermined duration is, e.g., 3 s.

Step S2: The coordinator 11 controls the further coordinator display 16 such that the further coordinator display 16 starts flashing. The flashing indicates that the bus arrangement 10 is in an addresses allocation mode or that the addresses allocation mode has been started. The addresses allocation mode can also be named configuration mode, addresses providing mode, addresses assignment mode or addressing mode. The coordinator 11 controls the coordinator display 15 such that the coordinator display 15 is off.

The coordinator 11 sends a broadcast message Bl to each of the plurality of subscribers 21 to 24 to reset each of the plurality of subscribers 21 to 24.

The coordinator 11 sends a broadcast message B2 to each of the plurality of subscribers 21 to 24 to set each of the plurality of subscribers 21 to 24 to “ready for a new node configuration”or “ready for receiving new subscriber addresses”.
Steps S3, 3′, 3″, 3″: After receiving the broadcast message B2 from the coordinator 11, each of the plurality of subscribers 21 to 24 controls its display 81 to 84 such that the displays 81 to 84 of each of the plurality of subscribers 21 to 24 indicate a first status. For example, the displays 81 to 84 indicate the first status by flashing. Each of the plurality of subscribers 21 to 24 is in a listen-only mode or only in a listen mode.

Thus, the coordinator 11 and the plurality of subscribers 21-24 are set in the addresses allocation mode. The following steps and messages belong to the addresses allocation mode.

Step S4: The coordinator 11 controls the coordinator display 15 such that the coordinator display 15 indicates a first subscriber number, e.g., 01 or 1. The coordinator display 16 is, e.g., flashing.

The coordinator 11 sends a first broadcast message B3 to each of the plurality of subscribers 21 to 24 “set node number 01 (wait for response)” or “set first subscriber number”. The first broadcast message B3 is a cyclic broadcast message.

Thus, the coordinator 11 indicates a first subscriber number NN and broadcasts a first broadcast message to the plurality of subscribers 21-24.

Step 5: A user selects a subscriber of the plurality of subscribers 21 to 24 as first subscriber 21 and presses the button 41 of the first subscriber 21 (e.g., longer than the predetermined duration). The user is a further user or the same user as mentioned above. By pressing the button 41 of the first subscriber 21, the first subscriber 21 is activated for communication.

The first subscriber 21 sends an acknowledge message MI to the coordinator 11. The acknowledge message M1 includes, e.g., a unique device identification number, abbreviated UDIN, of the first subscriber 21. The unique device identification number is, e.g., named unique device identifier. Each subscriber 21 has its individual UDIN. Two subscribers with an identical UDIN do not exist in the world.

Thus, in the addresses allocation mode after activation of the button 41 of the first subscriber 21 of the plurality of subscribers 21-24, the first subscriber 21 is activated and sends the acknowledge message M1 to the coordinator 11. Moreover, the first subscriber 21 after activation sends the acknowledge message M1 with the UDIN to the coordinator 11. The coordinator 11 stores the UDIN of the first subscriber 21.

The coordinator 11 sends a first subscriber number message M2 comprising the first subscriber number NN to the first subscriber 21 such that the first subscriber 21 is assigned to the first subscriber number NN. The first subscriber number NN is, e.g., 1 or 01 and can be named node number.

Step S6: The first subscriber 21 stores the first subscriber number NN in its memory 61. Only the activated first subscriber 21 of the plurality of subscribers 21-24 stores the first subscriber number NN in the memory 61 of the first subscriber 21.

The first subscriber 21 sends a confirmation message M3 to the coordinator 11 after storing the first subscriber number in the memory 61. The confirmation message M3 increases the safety of the method. The confirmation message M3 is optional.

Step S7: The first subscriber 21 controls its display 81 such that the display 81 indicates a second status, for example by continuously emitting light.

### Step SB: the First Subscriber 21 Switches to the Listen-only Mode.

As shown in FIG. 4B, the method comprises further steps. The procedure for providing the first subscriber number to the first subscriber 21 is repeated with the second subscriber 22 and the third subscriber 23. Each of the plurality of subscribers 21 to 24 with the exception of the first subscriber 21 indicate the first status, e.g., by flashing of the displays 82 to 84.

Step S9: The coordinator 11 controls the coordinator display 15 such that the coordinator display 16 indicates a second subscriber number NN, e.g., 02 or 2. The coordinator display 15 is, e.g., flashing.

The coordinator 11 sends a second broadcast message B4 to each of the plurality of subscribers 21 to 24 “set node number 02 (wait for response)” or “set second subscriber number”. The second broadcast message B4 is a cyclic broadcast message.

Step S10: The user selects a subscriber of the plurality of subscribers 21 to 24 as second subscriber 22 (with the exception of the first subscriber 21) and presses the button 42 of the second subscriber 22. By pressing the button 42 of the second subscriber 22, the second subscriber 22 is activated for communication.

The second subscriber 22 sends an acknowledge message M4 to the coordinator 11. The acknowledge message M4 includes an UDIN of the second subscriber 22.

The coordinator 11 sends a second subscriber number message M5 to the second subscriber 22 that the second subscriber 22 is assigned to the second subscriber number NN. The second subscriber number NN can be 02 or 2.

Step S11: The second subscriber 22 stores the second subscriber number NN in its memory 62.

The second subscriber 22 sends a confirmation message M6 to the coordinator 11.

Step S12: The second subscriber 22 controls its display 82 such that the display 82 shows the second status. For example, the display 82 is continuously on.

Step S13: The second subscriber 22 switches to the listen-only mode.

The bus arrangements 10 performs the steps S14 to S18 and communicates a third broadcast message B5 and the messages M7 to M9 as discussed above regarding the first and the second subscriber 21, 22. The coordinator 11 repeats the process until each of the plurality of subscribers 21-24 has been activated and has received a subscriber number NN.

Some of the steps can be implemented in another order. For example, the order of the steps S7 and SB can be switched. Some of the messages such as the confirmation message M3 are optional.

The coordinator memory 18 stores a table comprising the subscriber number NN, the corresponding UID and a status (the status can be, e.g., “stored”). The table can be named, e.g., a look-up table or a gateway node-address table.

In an alternative, not shown embodiment, the coordinator 11 indicates the first subscriber number NN on an external display in the addresses allocation mode. The coordinator 11 indicates also the second, the third etc. subscriber number NN on the external display.

In an alternative, not shown embodiment, the coordinator display 15 and the further coordinator display 16 are combined. One coordinator display 16 is designed to show the subscriber number and the status.

FIGS. 5A to 5D show an embodiment of a method which is a further development of the method shown above. In a first step ST1, the bus arrangement 10 is idle. In a second step ST2 (that follows the first step ST1), the coordinator button 17 is pressed by a user. The action of the user is illustrated by a bold arrow.

In a third step ST3 (that follows the second step ST2), the further coordinator display 16 and the displays 41-43 of the first, second and third subscriber 21-23 indicate a first status by flashing LEDs. The coordinator display 15 shows the first subscriber number 01. In a fourth step ST4 (that follows the third step ST3), the button 41 of the first subscriber 21 is pressed by the user. In a fifth step ST5 (that follows the fourth step ST4), the first subscriber number 01 is stored in the memory 61 of the first subscriber 25 21 and the display 81 of the first subscriber 21 indicates a second status, e.g., by a constant light provided by the LED of the display 81.

In a sixth step ST6 (that follows the fifth step ST5), the further coordinator display 16 and the displays 42, 43 of the second and third subscriber 22, 23 indicate the first status by flashing LEDs. The coordinator display 15 shows a second subscriber number NN=02. The button 42 of the second subscriber 22 is pressed by the user. In a seventh step ST7 (that follows the sixth step ST6), the second subscriber number NN=02 is stored in the memory 62 of the second subscriber 22 and the display 82 of the second subscriber 22 indicates the second status, e.g., by a constant light provided by the LED of the display 82.

In an eighth step ST8 (that follows the seventh step ST7), the further coordinator display 16 and the display 43 of the third subscriber 23 indicate the first status by flashing LEDs. The coordinator display 15 shows a third subscriber number 03. The button 43 of the third subscriber 23 is pressed by the user. In a ninth step ST9 (that follows the eighth step ST8), the third subscriber number 03 is stored in the memory 63 of the third subscriber 23 and the display 83 of the third subscriber 23 indicates the second status, e.g., by a constant light provided by the LED of the display 83.

In a last step STL (which is a tenth step that follows the 20 ninth step ST9), the coordinator button 17 is pressed by the user. This indicates the end of the addresses allocation mode.

In an alternative, not shown embodiment, the first to the third subscriber 21-23 are allocated in another way. For example, the first subscriber could alternatively be the subscriber at the end of the bus. The third subscriber could be the subscriber in the middle. The second subscriber could be the subscriber closet to the coordinator 11. Thus, the order of the subscribers can be designed to optimize the bus arrangement 10 or a machine which is controlled by means of the bus arrangement.

FIGS. 6A to 6F show an embodiment of a method which is a further development of the methods shown above. The bus 12 has a star form. The first to the ninth step ST1-ST9 and the last step STL shown in FIGS. 6A to 6F are similar to the first to the ninth step ST1-ST9 and the last step STL shown in FIGS. 5A to 5D. In a tenth and an eleventh step ST10, ST11, a fourth subscriber 24 receives a fourth subscriber number NN=4. In a twelfth and a thirteenth step ST12, ST13, a fifth subscriber 25 receives a fifth subscriber number NN=5.

FIG. 7 shows details of an embodiment of a bus arrangement 10 which is a further development of the embodiments shown above. The first subscriber 21 comprises an illuminated switch 94. The illuminated switch 94 can also be named backlit switch, backlighted switch, illuminated button or illuminated push-button. The illuminated switch 94 comprises the button 41 and the display 81. The illuminated switch 94 implements the function of the button 41 and the function of the display 81. The illuminated switch 94 can be inserted in one or more than one or all subscribers of the plurality of subscribers 21-33 described above.

The illuminated switch 94 combines the display 81 and the button 41 of a subscriber of the plurality of subscribers 21-33. For example, the display 81 is realized as a light source. The display 81 includes a first number of LEDs 95. In FIG. 7, the first number is 1. Alternatively, the first number is, e.g., 2, 3 or more than 0 or more than 1 or more than 2. In case the first number is more than 1, the LEDs of the first number of LEDs 95 emit light in different wavelength regions. For example, a first LED 95 of the first number of LEDs emits red light and a second LED of the first number of LEDs emits green light.

The button 41 is implemented, e.g., as push-button or switch. The switch is implemented, e.g., as a capacitive switch, mechanical switch, inductive switch, optical switch or membrane switch. A front cover 96 of the button 41 is illuminated by the display 81 which is located at the backside of the front cover 96. The front cover 96 is transparent or semi-transparent.

In FIG. 7, only an example of a schematic drawing of the illuminated switch 94 is shown. The button 41 comprises a flexible structure 97 and a carrier 98. The flexible structure 97 mechanically couples the front cover 96 to the carrier 98. In the example, the button 41 comprises a conductive part 99 (e.g., in the form of a metal ring) that is attached to the front cover 96. The button 41 comprises a first and a second conductor 100, 101 located at or on the carrier 98. In case a user provides a force (e.g., pushing force) to the front cover 96, the flexible structure 97 is bended and the conductive part 99 provides an electrical connection from the first conductor 100 to the second conductor 101. The light source, e.g., the LED 95, is attached to the carrier 98.

In an example, the coordinator 11 comprises the illuminated switch 94 as described above. The illuminated switch 94 comprises the coordinator button 17. The illuminated switch 94 comprises the further coordinator display 16 and/or the coordinator display 15.

In an alternative embodiment, not shown, the flexible structure 97 is realized as a spring, such as, e.g., a coil spring, cantilever spring or leaf spring.

In an alternative embodiment, not shown, the illuminated switch 94 can be realized as a touch screen. The touchscreen includes the display 81 and the button 41 which is implemented by a sensitive surface of the touchscreen. The sensitive surface realizes the function of the button 41.

In FIG. 7, only one example of an illuminated switch 94 is illustrated. There are many other forms of an illuminated switch 94 which can be used in subscribers 21 to 33 or in the coordinator 11.

In an example, the subscribers of the plurality of subscribers 21 to 33 are identical.

However, in typical applications, the subscribers of the plurality of subscribers 21 to 33 are different. They may have different functions such as the function of a circuit breaker, power switch, protection switch, contactor, sensor or measuring device etc. They may have different realizations of the displays 81 to 93 and/or the buttons 41 to 53. A display 81 and a button 41 can be realized as separate elements or combined in an illuminated switch 94.

The embodiments shown in FIGS. 1 to 7 as stated represent examples of the improved bus arrangement 10 and method; they do not constitute a complete list of all embodiments according to the improved bus arrangement 10 and method. An actual bus arrangement 10 or method may vary from the embodiments shown in terms of parts, structures, shape and order of method steps, for example.

### REFERENCE NUMERALS

10 bus arrangement
11 coordinator
12 bus
15 coordinator display
16 further coordinator display
17 coordinator button
18 coordinator memory
21 to 33 subscriber
41 to 53 button
61 to 73 memory
81 to 93 display
94 illuminated switch
95 light-emitting diode
96 front cover
97 flexible structure
98 carrier
99 conductive part
100, 101 conductor
B1, B2 broadcast message
B3 first broadcast message
B4 second broadcast message
B5 third broadcast message
GND ground potential
M1, M4, M7 acknowledge message
M2 first subscriber number message
M3, M6, M9 confirmation message
M5 second subscriber number message
M8 third subscriber number message
NN subscriber number
STL last step
ST1 to ST12 step
S1 to S9 step
VDD supply voltage

1. A bus arrangement, comprising:
a coordinator;
a plurality of subscribers, each comprising a button, a memory and a display; and
a bus which couples the coordinator to the plurality of subscribers, wherein the coordinator and the plurality of subscribers are configured to be set in an addresses allocation mode,
wherein in the addresses allocation mode, the coordinator is configured to indicate a first subscriber number and to broadcast a first broadcast message to the plurality of subscribers, and
wherein in the addresses allocation mode, after user activation of a button of a first subscriber of the plurality of subscribers in response to the indication of the first subscriber number and broadcast of the first broadcast message, the first subscriber is configured to be activated and to send an acknowledge message with a unique device identification number to the coordinator,
wherein the coordinator is configured to store the unique device identification number together with the first subscriber number.

2. The bus arrangement of claim 1,
wherein the coordinator comprises a coordinator display and is configured to indicate the first subscriber number on the coordinator display in the addresses allocation mode, and/or
wherein the coordinator is configured to indicate the first subscriber number on an external display in the addresses allocation mode.

3. The bus arrangement of claim 1, wherein in the addresses allocation mode, the coordinator is configured to send a first subscriber number message comprising the first subscriber number to the first subscriber, and
wherein in the addresses allocation mode, only the activated first subscriber of the plurality of subscribers is configured to store the first subscriber number in the memory of the first subscriber.

4. The bus arrangement of claim 3, wherein the first subscriber is configured to send a confirmation message to the coordinator after storing the first subscriber number in the memory.

5. The bus arrangement of claim 1, wherein at the start of the addresses allocation mode the coordinator is configured to send a broadcast message to each of the plurality of subscribers such that each of the plurality of subscribers is set in a listen-only mode and the display of each of the plurality of subscribers is configured to indicate a first status.

6. The bus arrangement of claim 5, wherein after activation of the first subscriber, the first subscriber is configured to control the display such that the display indicates a second status.

7. The bus arrangement of claim 1, wherein the display of each of the plurality of subscribers comprises a light-emitting diode.

8. The bus arrangement of claim 7, wherein the display of each of the plurality of subscribers is configured to indicate a first status by a flashing light-emitting diode and to indicate a second status by a continuously emitting light-emitting diode.

9. The bus arrangement of claim 1, wherein the coordinator is configured to repeat the process until each of the plurality of subscribers has been activated and has received a subscriber number.

10. The bus arrangement of claim 1, wherein the bus is realized as one of a group consisting of a two-wire bus, three-wire bus or four-wire bus.

11. The bus arrangement of claim 1, wherein the bus is arranged as one of a linear bus, a star bus, a ring bus or a mixture of these bus forms.

12. The bus arrangement of claim 1, wherein the coordinator is implemented as a gateway.

13. The bus arrangement of claim 1, wherein the coordinator is implemented as a programmable logic controller.

14. The bus arrangement of claim 1, wherein the coordinator is implemented as a master and the plurality of subscribers are implemented as slaves.

15. The bus arrangement of claim 1, wherein a subscriber of the plurality of subscribers is one of a group consisting of a circuit breaker, power switch, protection switch, contactor, sensor and measuring device.

16. The bus arrangement of claim 1, wherein a subscriber of the plurality of subscribers comprises an illuminated switch which comprises the button and the display.

17. A method for operating a bus arrangement, wherein the bus arrangement comprises:
a coordinator;
a plurality of subscribers each comprising a button, a memory and a display; and
a bus which couples the coordinator to the plurality of subscribers, wherein the methods comprises:
setting the coordinator and the plurality of subscribers in an addresses allocation mode,
in the addresses allocation mode, indicating a first subscriber number by the coordinator and broadcasting a first broadcast message to the plurality of subscribers by the coordinator,
in the addresses allocation mode, after user activation of a button of a first subscriber of the plurality of subscribers in response to the indication of the first subscriber number and broadcast of the first broadcast message, activating the first subscriber and sending an acknowledge message with a unique device identification number by the first subscriber to the coordinator, and
storing, by the coordinator, the unique device identification number together with the first subscriber number.
